(19) United States
(12) Patent Application Publication
(10) Pub. No.: US 2001/0010057 A1
(43) Pub. Date: Jul. 26, 2001

(54) Semiconductor integrated circuit, computer system, data processor and data processing method

(75) Inventor: Toshio Yamada, Shiga (JP)

Correspondence Address: Michael E. Fogarty, McDermott, Will & Emery, 1600 13th Street, N.W., Washington, DC, 20005-3096, US

(73) Assignee: Matsushita Electronics Corporation, Osaka (JP)

(21) Appl. No.: 09/779,751

(22) Filed: Feb. 9, 2001

Related U.S. Application Data
(62) Division of application No. 09/102,166, filed on Jun. 22, 1998.

(30) Foreign Application Priority Data
Jun. 24, 1997 (JP) 9-167612

(51) Int. Cl. G06F 15/16; G06F 17/21; G06F 17/24

(52) U.S. Cl. 709/203; 707/513

(57) ABSTRACT

A memory having a data processing function is connected with a memory network such as a memory bus. A memory controller writes data to be processed in a predetermined area in the memory having the data processing function. The memory having the data processing function processes the written data and stores resultant processed data. Thereafter, the memory controller reads the stored resultant processed data. Accordingly, work data (intermediate data obtained during the processing) is not transferred to the memory controller through the memory bus but is processed within the memory having the data processing function. As a result, the data processing ability can be improved. In the memory having the data processing function, a processing specification for the processing to be executed is written immediately before executing the processing. Accordingly, no work data is transferred through the memory bus between a CPU and the memory serving as a work area for the processing. Thus, the data processing ability can be improved.

### BACKGROUND OF THE INVENTION

The present invention relates to a semiconductor integrated circuit provided with a semiconductor device having a data processing function, and a computer system, a data processor and a data processing method using the semiconductor device.

FIG. 11 shows an example of a conventional computer system. This computer system has an acceleration function. In FIG. 11, reference numerals 1 and 1′ denote CPUs, a reference numeral 2 denotes a host bus, and a reference numeral 3 denotes a core logic connected with the CPUs 1 and 1′ through the host bus 2. Also, a reference numeral 5 denotes a memory bus, and reference numerals 6 and 7 denote memories, which are connected with a memory controller 4 included in the core logic 3 through the memory bus 5. The core logic 3 is connected with a hard disk device (HDD) 11 through a peripheral equipment bus 10.

FIG. 12 shows another example of the conventional computer system. The computer system of FIG. 12 includes merely one CPU 1 and a DSP board 12 with an acceleration function connected with the peripheral equipment bus 10.

However, in a predetermined data processing by using the conventional system of FIG. 11, a processing for transferring work data (intermediate data) between the CPU 1 or 1′ and the memory 6 or 7 serving as a working area through the data bus 5 is disadvantageously slow. Also, in transferring work data between the DSP board 12 and the memory 6 or 7 in the conventional system of FIG. 12, a data transferring processing through the memory bus 5 and the peripheral equipment bus 10 is disadvantageously slow because data transfer through the peripheral equipment bus 10 is also slow. Accordingly, both the conventional computer systems have a problem that the data processing ability cannot be improved for their cost because of the slow data transfer from the memories 6 and 7 serving as the work areas through the buses 5 and 10.

### SUMMARY OF THE INVENTION

The object of the invention is improving the data processing ability in a data processing by eliminating transfer of work data between a CPU, a DSP board or the like and a memory.

In order to achieve this object, according to the present invention, a semiconductor device having a data processing function is connected with a memory network including a memory bus or the like, so as to execute a data processing within the semiconductor device. Thus, the transfer of work data can be eliminated and the aforementioned problem can be overcome.

Specifically, the computer system of this invention comprises a semiconductor device connected with a memory network and having a data processing function.

Alternatively, the computer system of this invention comprises a CPU; a host bus connected with the CPU; a core logic connected with the CPU through the host bus and including a memory controller; a memory network connected with the memory controller included in the core logic; a semiconductor device connected with the memory network and having no data processing function; a semiconductor device connected with the memory network and having a data processing function; a peripheral equipment bus connected with the core logic; and a mass storage device connected with the peripheral equipment bus.

In one aspect of the computer system, the semiconductor device having the data processing function is formed as a module.

Alternatively, the computer system of this invention comprises a semiconductor device connected with a memory network, serving as a memory accessed by a controller through the memory network and having a data processing function.

Alternatively, the computer system of this invention comprises a semiconductor device connected with a memory network and having a memory emulation function.

Furthermore, the data processing method of this invention comprises the steps of writing data to be processed in a predetermined area within a room of a semiconductor device having a data processing function and serving as a memory; processing the data by the semiconductor device and writing resultant processed data in the predetermined area or another predetermined area within the room; and obtaining the resultant processed data by reading the predetermined area or the other predetermined area within the room of the semiconductor device after writing the resultant processed data.

Alternatively, in the data processing method of this invention, a data processor including a controller and a semiconductor device having a data processing function and serving as a memory is used, the controller writes specification information of a processing to be executed in a first area within a room of the semiconductor device and writes data to be processed in a second area within the room; the semiconductor device subsequently processes the data written in the second area on the basis of the processing specification information written in the first area within the room, and writes resultant processed data in a third area within the room; and the controller reads the resultant processed data from the third area within the room.

In one aspect of this data processing method, the second area and the third area within the room of the semiconductor device are the same area, and the semiconductor device overwrites the resultant processed data in the second area where the data has been written.

In another aspect of the data processing method, the controller reads time information required for the processing to be executed, and reads the resultant processed data written in the third area within the room on the basis of the read time information after time corresponding to the time information elapses.

In still another aspect of the data processing method, the semiconductor device is connected with the controller through a memory network, and the controller stores time information required for each processing to be executed by the semiconductor device.

In still another aspect of the data processing method, immediately before executing the processing by the semiconductor device having the data processing function, information describing the processing to be executed is dynamically rewritten for executing the processing.

Moreover, the data processor of this invention comprises a controller; a semiconductor device connected with the controller through a memory network and having a data processing function; and informing means for informing the controller that the semiconductor device has the data processing function and what type of data processing function the semiconductor device has.

Furthermore, in the data processing method of this invention, a data processor including a controller, a semiconductor device connected with the controller through a memory network and having a data processing function and a semiconductor device connected with the memory network and having no data processing function is used, the controller repeatedly writes identification request information in a predetermined address of the semiconductor devices connected with the memory network, with a semiconductor device identification address successively varied; the semiconductor device having the data processing function changes the written identification request information in accordance with the data processing function thereof; the controller repeatedly reads data stored in the predetermined address of the semiconductor devices connected with the memory network, with the semiconductor device identification address successively varied again; and the controller recognizes that each of the semiconductor device has or dose not have a data processing function and what type of data processing function the semiconductor device has.

In addition, in the computer system, the data processor or the data processing method of this invention, the memory network has a bus network structure.

Alternatively, in the computer system, the data processor or the data processing method of this invention, the memory network has a ring network structure.

Moreover, the semiconductor integrated circuit of this invention comprises a semiconductor device serving as a memory and having a data processing function; and changing means for dynamically changing a relationship between a logical address within a memory address space allocated to the semiconductor device and an actual physical address.

Furthermore, the computer system of this invention comprises plural memory networks; and a semiconductor device having a data processing function, wherein the semiconductor device is connected with the plural memory networks and has a data exchange function to transfer data between the plural memory networks.

Additionally, the computer system of this invention comprises a semiconductor device connected with a memory network and having a data processing function and an image displaying function.

As described above, when a data processing such as an arithmetic processing is required, the semiconductor device having a data processing function executes the data processing in this invention. Therefore, there is no need to transfer work data between a CPU, a DSP board or the like and the semiconductor device through a memory network, and resultant processed data obtained by the semiconductor device alone is transferred to the CPU, the DSP board or the like. As a result, the data processing ability can be greatly improved.

### BRIEF DESCRIPTION OF THE DRAWINGS

FIG. 1 is a diagram for showing the configuration of a computer system according to a first embodiment of the invention;

FIGS. 2(a) through 2(c) illustrate a dynamic address renaming function according to a second embodiment of the invention, wherein FIG. 2(a) is a diagram for showing a logical map of a memory having a data processing function, FIG. 2(b) is a diagram for showing a physical map of the memory before conducting a copying processing and FIG. 2(c) is a diagram for showing the physical map after conducting the copying processing;

FIG. 3 is a circuit diagram of an actual memory for realizing the dynamic address renaming function of the second embodiment;

FIG. 4 is a diagram for showing the rough configuration of a memory having a data processing function according to a third embodiment of the invention;

FIGS. 5(a) and 5(b) are diagrams for illustrating a first half and a second half of the operation of the memory having a data processing function of the third embodiment, respectively;

FIG. 6 is a diagram for showing a specific inside configuration of a data processor according to a fourth embodiment of the invention;

FIG. 7 is a diagram for showing a specific inside configuration of a data processor according to a fifth embodiment of the invention;

FIG. 8 is a diagram for showing the rough configuration of an entire computer system according to a sixth embodiment of the invention;

FIG. 9 is a diagram for showing the inside configuration of a shared memory having a data processing function of the sixth embodiment;

FIG. 10 is a diagram for showing the inside configuration of a programmable row decoder;

FIG. 11 is a diagram for showing an example of a conventional computer system; and

FIG. 12 is a diagram for showing another example of the conventional computer system.

### DETAILED DESCRIPTION OF THE INVENTION

### EMBODIMENT 1

A first embodiment of the invention will now be described.

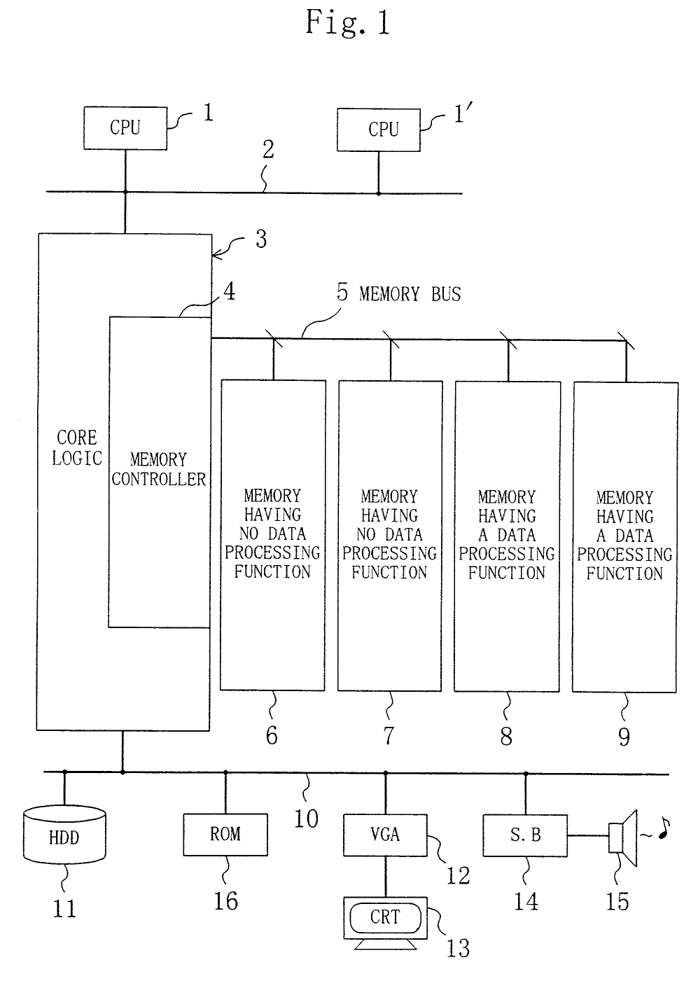

FIG. 1 shows the entire configuration of a computer system of this embodiment. In FIG. 1, CPUs 1 and 1′ are connected with a core logic 3 through a host bus 2. The core logic 3 includes a memory controller (controller) 4, which is connected with a memory bus (memory network) 5. The memory bus 5 is connected with memories 6 and 7 not provided with a data processing function (semiconductor devices having no data processing function) and memories 8 and 9 having a data processing function such as an arithmetic processing function (semiconductor devices having a data processing function), so that the memory controller 4 can control the memories 6 through 9 through the memory bus 5. The semiconductor devices 8 and 9 having the data processing functions have a memory emulation function over the memory controller 4. Each of the four memories 6 through 9 is formed as a single chip or a module of SIMM or DIMM.

The core logic 3 is connected, through a peripheral equipment bus 10 such as a PCI bus, with a hard disk device (mass storage device) 11, a ROM 16, a graphic card (VGA card) 12 and a voice/sound board 14. The VGA card 12 is connected with a CRT device 13 and the voice/sound board 14 is connected with a loud speaker 15.

Now, the operation of the computer system of FIG. 1 will be described.

First, when a power source is turned on, a system starting program is loaded from the ROM 16 into the CPU 1. As a result, the CPU 1 starts to check the structure of the system. This check is performed on the memories as follows: First, with a semiconductor device identification address successively varied, data corresponding to a request command (identification request information) is written in a leading address of each of the memories 6 through 9. Then, after a predetermined time period, data in the same address of each memory is read.

During the time period, in each of the memories 8 and 9 having the data processing function, the written request command is decoded, and in accordance with the request command, information on a type of its own data processing function is overwritten in the address where the request command has been written. This structure constitutes informing means for informing that the memories 8 and 9 have the data processing functions and what types of data processing functions they have.

As a result, in the two memories 6 and 7 having no data processing function, the data have not been changed when the addresses are accessed again, while the data are replaced with the information on their data processing functions in the other two memories 8 and 9 having the data processing functions. Accordingly, the CPU 1 and the memory controller 4 are informed, by reading the data in the addresses, that a memory having what type of data processing function is disposed in which position in the memory map.

Next, the operation of the computer system of this embodiment will be described with an actual data processing exemplified. In the exemplified data processing described below, a bit stream of the moving picture encoding standard MPEG2 is decoded as in a DVD device or the like. In this embodiment, bit stream data of the MPEG2 is assumed be stored in the hard disk device 11.

The bit stream data stored in the hard disk device 11 is input to the CPU 1 through the peripheral equipment bus 10 and the core logic 3 for a preprocessing. In this preprocessing, the bit stream data is separated into speech data and image data. Then, the separated speech data is loaded into a room corresponding to one of the memories having the data processing functions (for example, the memory 8), and the separated image data is loaded into another room corresponding to the other memory 9 having the data processing function.

The memory 8 having the data processing function processes the speech data, and the other memory 9 decodes (expands) the image data, and the respective memories write data resulting from the speech processing and the image processing in predetermined address areas in their rooms. The operations of these memories will be described in detail in a third embodiment below.

Then, after a predetermined time period required for completing the data processing by the memories 8 and 9 having the data processing functions, the CPU 1 accesses the address areas storing the resultant data in the rooms of the two memories 8 and 9 having the data processing functions, and fetches the resultant data. The predetermined time period required for completing the data processing, namely, time information required for the data processing, is stored in the memory controller 4 or the CPU 1 as a table listing information on respective processing, and the controller 4 or the CPU 1 reads and grasps the time data corresponding to the processing before conducting the processing. The table is previously built in accordance with, for example, a volume of data to be processed and the contents of the processing.

Then, the resultant data of the speech data processing is transferred to the voice board 14 through the peripheral equipment bus 10 so as to be output as a voice from the loud speaker 15. Similarly, the resultant data of the image data processing is transferred to the VGA card 12 through the peripheral equipment bus 10 so as to be displayed on the CRT device 13.

In this embodiment, among the two memories 8 and 9 having the data processing functions, the memory 8 is used for the speech processing and the memory 9 is used for the image processing. However, the data processing conducted by these memories are not necessarily fixed, and it is possible to realize one processing as a whole with the processing function of each memory varied if necessary. Specifically, information required for a data processing can be written in the memories 8 and 9 having the data processing functions before conducting the data processing, so that the memories 8 and 9 can conduct the data processing on the basis of the information. For example, when an image compression function is loaded into the memory 8 having the data processing function before conducting an image compression processing, the digital video recording can be conducted by using the image compression function.

In this computer system, separated data and a program for processing the data are paired to be distributed to the memory 8 or 9 having the data processing function, and work data is transferred within the memory 8 or 9 alone. Therefore, the data transfer can be performed at a high speed. Accordingly, the memory bus 5 is not used for the transfer of the work data, resulting in greatly improving the performance of the entire computer system.

Although the computer system of this embodiment is of a bus structure in which the memories 8 and 9 having the data processing functions are connected in parallel, the invention is not limited to this bus structure system. For example, the computer system can be of a ring structure in which the memory controller 4, the memory 6, the memory 7 beside, the memory 8 beside and the like are successively connected in a point-to-point manner to be returned to the memory controller 4. Significantly, the invention is applicable to any memory network including the bus structure and the ring structure.

Furthermore, although the VGA card 12 is connected with the peripheral equipment bus 10 in this embodiment, the VGA card 12 can be omitted by providing the memory 8 or 9 having the data processing function with an image displaying function in addition to the data processing function or by dynamically writing the image display function immediately before the image display.

### EMBODIMENT 2

A second embodiment of the invention will now be described. The second embodiment relates to the inside configuration of the memories 8 and 9 having the data processing functions adopted in the computer system of the first embodiment. In this embodiment, a dynamic address renaming function relating to a copying processing in a room widely adopted in an actual data processing will be described.

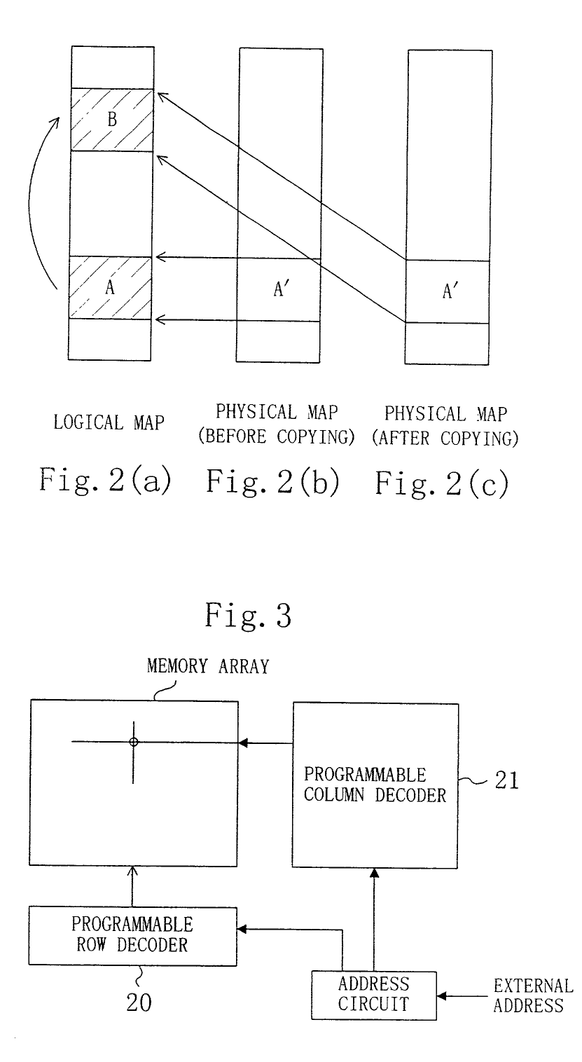

FIG. 2(a) shows a logical map of the memory 8 or 9 having the data processing function. In a work described below, data stored in an area A of FIG. 2(a) is copied in an area B. In conducting this work in a conventional computer system, an operation for reading a part of data stored in the memory area A into the CPU and an operation for writing the read data again in the memory area B are repeated. In these operations, however, a traffic volume on a memory bus is so large that the performance of the entire system is degraded. According to this embodiment, this work is realized by using the dynamic address renaming function.

In the dynamic address renaming function, a relationship between a logical memory map from a view point of the CPU and a physical memory map from a view point of the alignment of memory cells in the memory is dynamically changed, thereby realizing the data copying processing described above.

Specifically, a physical area A′ corresponds to the logical area A before conducting the copying processing as is shown in a physical map before conducting the copying processing of FIG. 2(b), but after conducting the copying processing, the physical area A′ is made to correspond to the logical area B as is shown in FIG. 2(c). In this manner, the data can be copied without causing any traffic in the memory bus.

FIG. 3 shows an actual configuration for realizing this function. A member in a memory for actually converting a logical address into physical position information of a memory cell is a selecting device like a row decoder and a column decoder. The dynamic address renaming function can be realized by providing a programmable row decoder 20 and a programmable column decoder 21, which are obtained by making a row decoder and a column decoder programmable, and by dynamically changing their association.

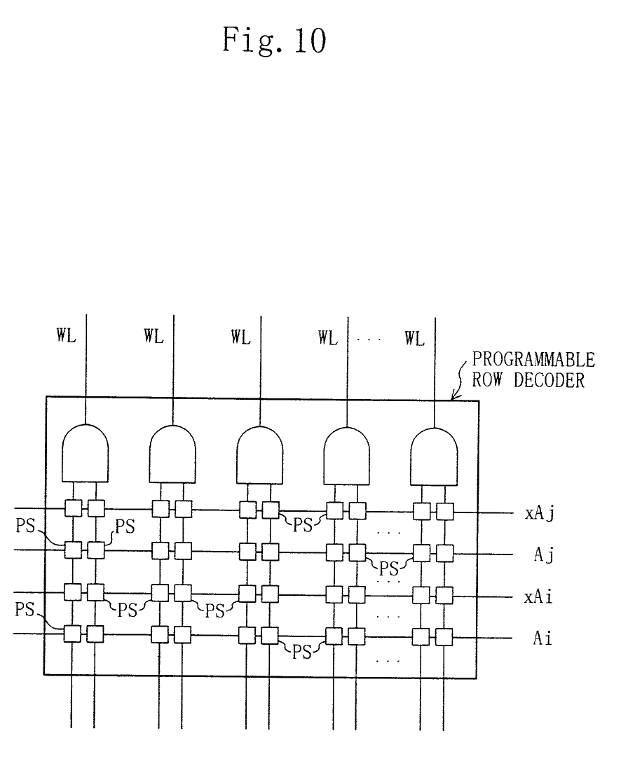

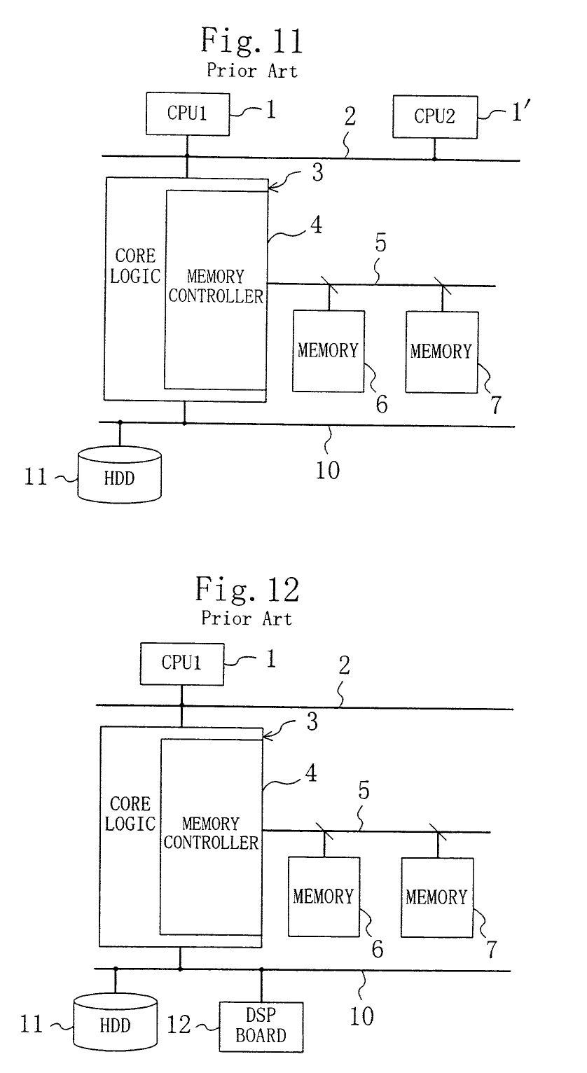

FIG. 10 shows an example of the inside configuration of the programmable row decoder 20. As is shown in FIG. 10, a large number of programmable switching devices PS are aligned, so as to dynamically change a word line selected among provided word lines WL on the basis of address signal lines Ai, xAi, Aj and xAj and a rename signal supplied by the memory controller 4 of FIG. 1. The programmable column decoder 21 can be realized by adopting a similar inside configuration.

The effect of this embodiment can be exhibited merely in the data copying processing within the same memory. In a recent computer, the number of memory chips per CPU is decreased as the improvement of the integration of a DRAM. Therefore, this embodiment can exhibit a remarkable effect in such a structure.

### EMBODIMENT 3

A third embodiment of the invention will now be described. This embodiment relates to a configuration of a memory capable of a more complicated data processing than the copying processing of the second embodiment in the computer system of the first embodiment.

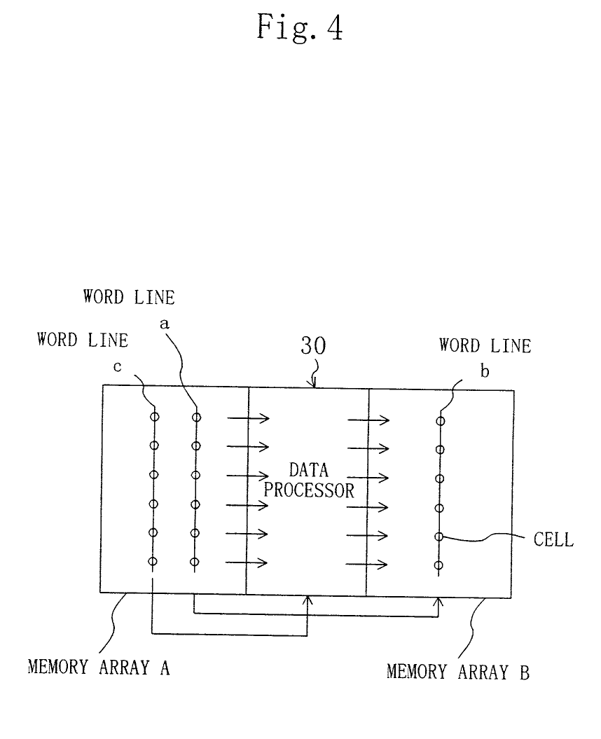

FIG. 4 shows the configuration of a memory having a data processing function of this embodiment.

As is shown in FIG. 4, each of two memory arrays (memory space) A and B is an array of memory cells of DRAM or SRAM including a large number of memory cells aligned in an array, a large number of bit lines extending in a column direction and a large number of word lines extending in a row direction. At the center, a data processor 30 capable of conducting the same processing on mass data in a batch is disposed.

Now, a data processing by using this memory will be described. First, the memory controller 4 of FIG. 1 writes data processing specification information in the memory cells (first area) connected with the word line c in the memory array A, so as to transfer the data processing specification information to the data processor 30 in a batch. This transfer defines the operation of the data processor 30, namely, the processing specification.

Next, the memory controller 4 writes data to be processed in the memory cells (second area) connected with the other word line a in the memory array A, so as to transfer the data to the data processor 30 in a batch after the definition of the processing specification for the data processor 30. The data processor 30 processes the transferred data in accordance with the defined processing specification, and stores resultant processed data in, for example, the memory cells (third area) connected with the word line b in the memory array B. Alternatively, the memory cells for storing the resultant data can be the same as the memory cells for storing the data to be processed, so that the resultant data can be overwritten in these memory cells.

In this manner, mass data and data processing specification information are transferred between the memory arrays A and B and the data processor 30, and the bit width is hyper-wide-bit data of, for example, 1024 bits.

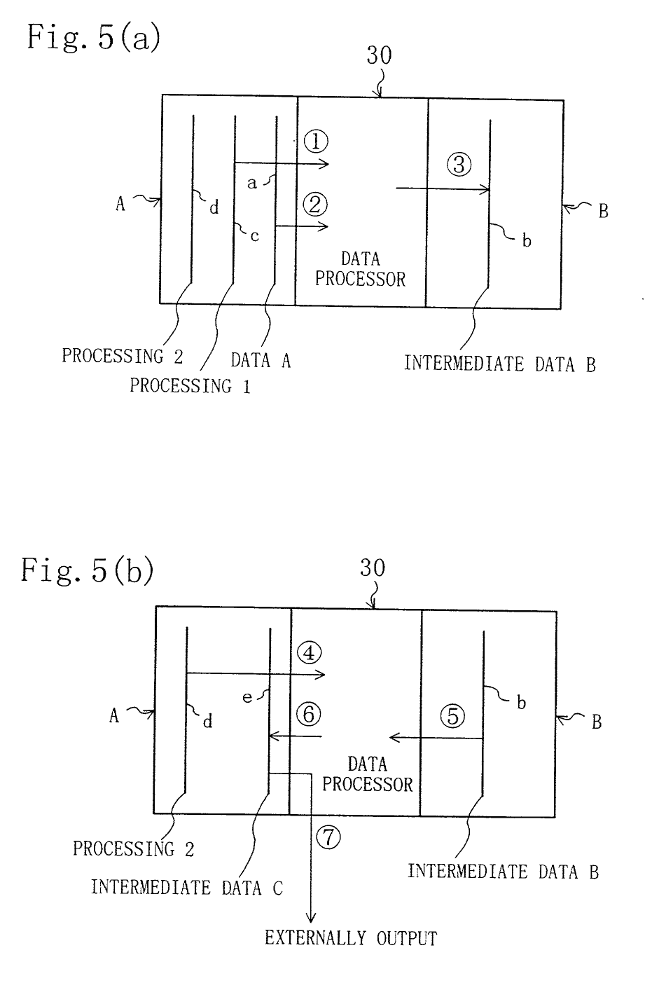

Then, when another different processing is to be executed, another data processing specification information is stored in the memory cells connected with another word line in the memory array, and the processing specification information is loaded into the data processor 30 in a batch again. Then, resultant data stored in the memory cells connected with the word line b in the memory array B is returned to the data processor 30, so that the different processing is conducted on the resultant data in accordance with the different data processing specification information. This operation will now be described with reference to FIGS. 5(a) and 5(b).

As is shown in FIG. 5(a), the data processing specification information stored in the memory cells connected with the word line c in the memory array A is first transferred to the data processor 30 in a batch. Next, the data stored in the memory cells connected with the word line a in the memory array A is transferred to the data processor 30 in a batch. The data processor 30 processes the transferred data in accordance with the transferred data processing specification information, and stores resultant data as intermediate data B in the memory cells connected with the word line b in the memory array B.

Then, as is shown in FIG. 5(b), the different data processing specification information stored in the memory cells connected with the word line d in the memory array A is loaded into the data processor 30 in a batch, and the intermediate data B is successively transferred to the data processor 30. The data processor 30 processes the intermediate data B in accordance with the loaded different data processing specification information, and stores thus obtained resultant data C in the memory cells connected with the word line e in the memory array A. The resultant data C is externally read by the memory controller 4.

In such a data processing, although overhead for rewriting the processing specification is caused in the data processor 30, mass data can be processed in a batch, and hence, the data processing ability can be largely improved as a whole. Specifically, the entire data processing is decomposed so that simple and mass data can be processed in a batch, and the decomposed processing are continuously executed for realizing the entire processing. As a result, high performance can be attained.

### EMBODIMENT 4

A fourth embodiment of the invention will now be described.

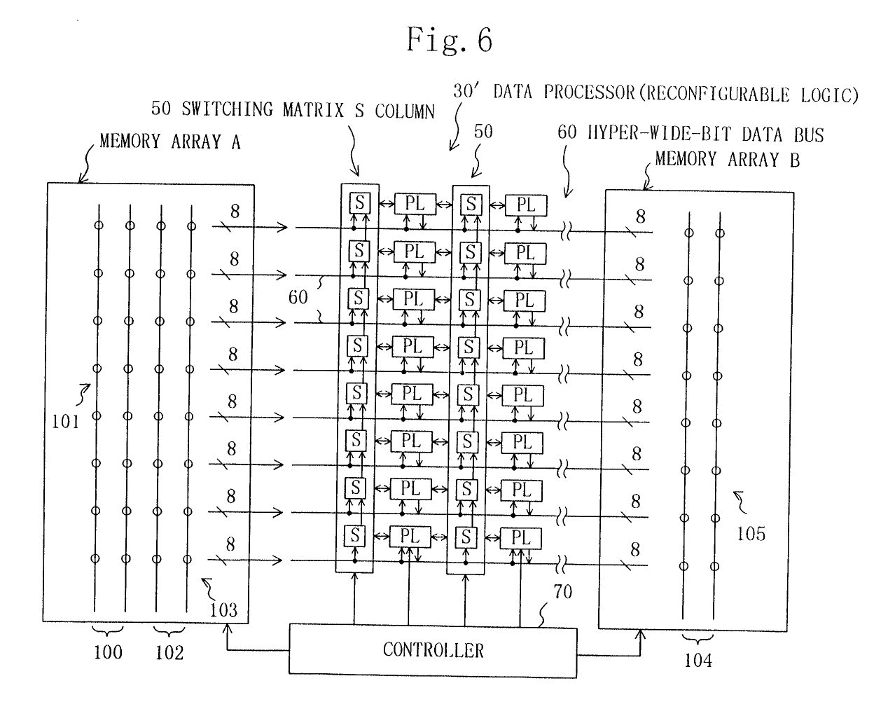

FIG. 6 shows the detailed inside configuration of the memory having the data processing function of FIG. 4.

In FIG. 6, memory arrays A and B each including hyper-wide-bit data buses 60 are disposed in a left portion and a right portion, respectively. Between the memory arrays A and B, switching matrix S columns 50 and programmable logics PL are disposed in an array. The switching matrix S columns 50 and the programmable logics PL aligned at the center constitute a data processor 30′ of re-programmable reconfigurable logic. A controller 70 controls the memory arrays A and B, the switching matrix S columns 50 and the programmable logics PL.

In the memory array A, a first memory cell group 101 is connected with a first word line group 100, and a large number of memory cells belonging to, the first memory cell group 101 store data processing specification information for the data processor 30′. A second memory cell group 103 is connected with a second word line group 102, and a large number of memory cells belonging to the second memory cell group 103 store data to be processed. Furthermore, in the memory array B, a third memory cell group 105 is connected with a third word line group 104, and a large number of memory cells belonging to the third memory cell group 105 are used for storing resultant processed data.

In this case, each of the switching matrix S columns 50 transfers and receives data to and from the programmable logic PL and also conducts data transfer among bits between the hyper-wide-bit data buses 60 (in the vertical direction in FIG. 6).

Now, the operation of the memory having the data processing function of this embodiment will be described.

First, the data processing specification information stored in the first memory cell group 101 is loaded into the data processor 30′ from the memory array A through the hyper-wide-bit data buses 60. This processing specification information is composed of connection information of the switching matrix S columns 50 and program information of the programmable logics PL. Then, the data to be processed stored in the second memory cell group 103 is loaded into the data processor 30′ from the memory array A. Resultant processed data obtained by the data processor 30′ is stored in the third memory cell group 105 of the memory array B. A series of such operations are controlled by the controller 70.

In the configuration shown in FIG. 6, the two memory arrays A and B are physically separated, but these arrays are not necessarily separated.

### EMBODIMENT 5

A fifth embodiment of the invention will now be described. In this embodiment, the memory having the data processing function of FIG. 6 is further improved.

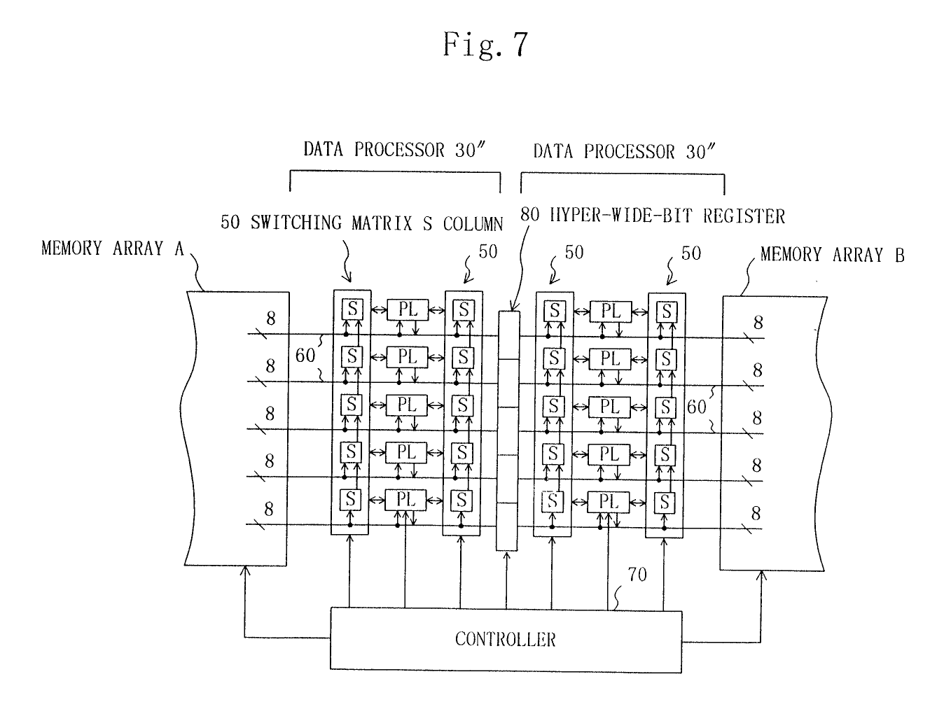

FIG. 7 shows the configuration of a memory having a data processing function of this embodiment. In FIG. 7, hyper-wide-bit registers 80 are aligned at the center, and data processors 30″ are disposed at right and left sides of the hyper-wide-bit registers 80. Each of the data processors 30″ includes, similarly to that of the fourth embodiment, switching matrix S columns 50 and programmable logics PL aligned in an array.

In the memory having the data processing function of this embodiment, the two data processors 30″ can be independently operated, and hence, time required for loading data processing specification information can be apparently hidden. Specifically, the following two phases can be alternately repeated:

Phase 1: One processor performs the data processing, and the processing specification information is loaded into the other processor; and

Phase 2: The processing specification information is loaded into one processor, and the other processor performs the data processing.

### EMBODIMENT 6

A sixth embodiment of the invention will now be described.

In this embodiment, a memory having a data processing function and including hyper-wide-bit registers 80 disposed at the center similarly to that of the fifth embodiment is used for realizing higher dual port application.

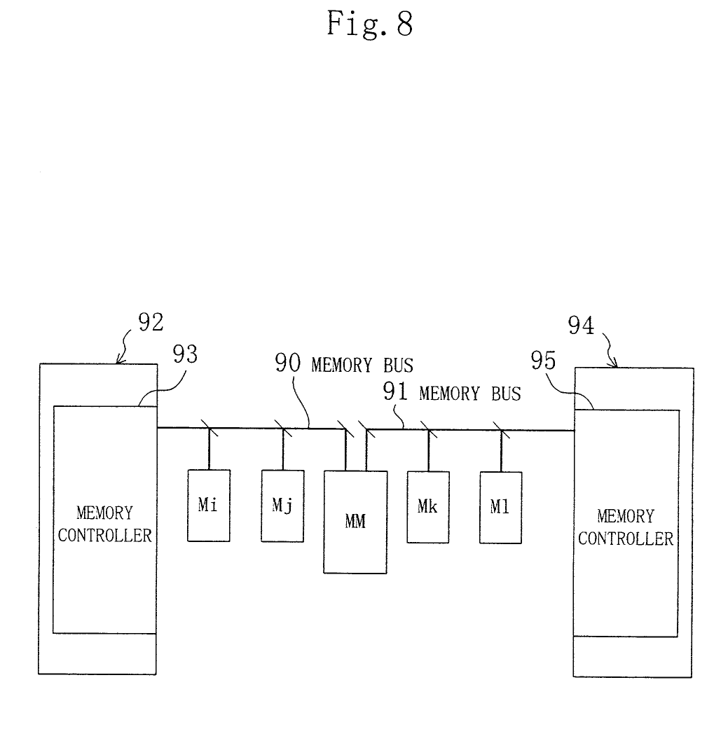

The dual port application means a configuration as is shown in FIG. 8. Specifically, a memory MM having a data processing function is shared as a shared memory by two memory buses 90 and 91 working as memory networks. In FIG. 8, Mi and Mj indicate memories having or not having a data processing function connected with the memory bus 90 alone, which are controlled by a memory controller 93 included in a core logic 92. Similarly, Mk and Ml indicate memories having or not having a data processing function connected with the memory bus 91 alone, which are controlled by a memory controller 95 included in a core logic 94.

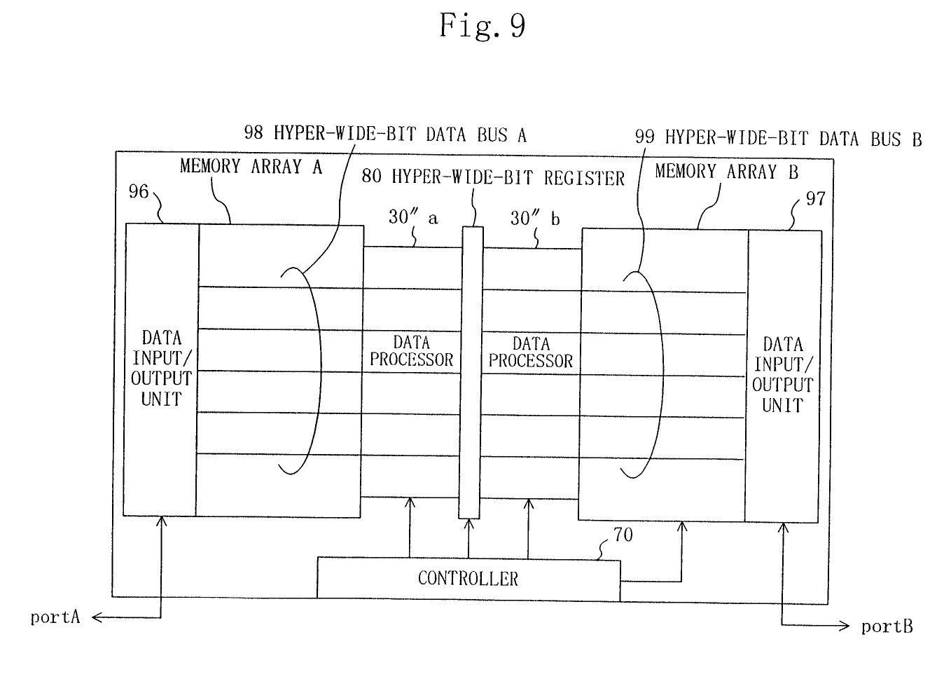

FIG. 9 shows the inside configuration of the memory MM having the data processing function. As is shown in FIG. 9, hyper-wide-bit registers 80 are aligned at the center, and at left and right sides thereof, data processors 30″a and 30′b, memory arrays A and B, and data input/output units 96 and 97 are respectively disposed outward in this order. These members are connected by hyper-wide-bit data buses 98 and 99.

By adopting this configuration, the data transfer between the two memory buses A and B and the data processing can be simultaneously executed.

What is claimed is:

1. A computer system comprising:
a semiconductor device connected with a memory network and having a data processing function.

2. A computer system comprising:
a CPU;
a host bus connected with said CPU;
a core logic connected with said CPU through said host bus and including a memory controller;
a memory network connected with said memory controller included in said core logic;
a semiconductor device connected with said memory network and having no data processing function;
a semiconductor device connected with said memory network and having a data processing function;
a peripheral equipment bus connected with said core logic; and
a mass storage device connected with said peripheral equipment bus.

3. The computer system of claim 2,
wherein said semiconductor device having the data processing function is formed as a module.

4. A computer system comprising:
a semiconductor device connected with a memory network, serving as a memory accessed by a controller through said memory network and having a data processing function.

5. A computer system comprising:
a semiconductor device connected with a memory network and having a memory emulation function.

6. A data processing method comprising the steps of:
writing data to be processed in a predetermined area within a memory space of a semiconductor device having a data processing function and serving as a memory;
processing said data by said semiconductor device and writing resultant processed data in said predetermined area or another predetermined area within said room; and
obtaining said resultant processed data by reading said predetermined area or said another predetermined area within said room of said semiconductor device after writing said resultant processed data.

7. A data processing method by using a data processor including a controller and a semiconductor device having a data processing function and serving as a memory,
wherein said controller writes specification information of a processing to be executed in a first area within a room of said semiconductor device and writes data to be processed in a second area within said room,
said semiconductor device subsequently processes said data written in said second area on the basis of said processing specification information written in said first area within said room, and writes resultant processed data in a third area within said room, and
said controller reads said resultant processed data from said third area within said room.

8. The data processing method of claim 7,
wherein said second area and said third area within said room of said semiconductor device are the same area, and
said semiconductor device overwrites said resultant processed data in said second area where said data has been written.

9. The data processing method of claim 7,
wherein said controller reads time information required for said processing to be executed, and reads said resultant processed data written in said third area within said room on the basis of said read time information after time corresponding to said time information elapses.

10. The data processing method of claim 9,
wherein said semiconductor device is connected with said controller through a memory network, and
said controller stores time information required for each processing to be executed by said semiconductor device.

11. The data processing method of claim 7, 8, 9 or 10,
wherein, immediately before executing said processing by said semiconductor device having the data processing function, information describing said processing to be executed is dynamically rewritten for executing said processing.

12. A data processor comprising:
a controller;
a semiconductor device connected with said controller through a memory network and having a data processing function; and
informing means for informing said controller that said semiconductor device has the data processing function and what type of data processing function said semiconductor device has.

13. A data processing method by using a data processor including a controller, a semiconductor device connected with said controller through a memory network and having a data processing function and a semiconductor device connected with said memory network and having no data processing function,
wherein said controller repeatedly writes identification request information in a predetermined address of said semiconductor devices connected with said memory network, with a semiconductor device identification address successively varied;
said semiconductor device having the data processing function changes the written identification request information in accordance with the data processing function thereof;
said controller repeatedly reads data stored in said predetermined address of said semiconductor devices connected with said memory network, with said semiconductor device identification address successively varied again; and
said controller recognizes that each of said semiconductor device has or dose not have a data processing function and what type of data processing function said semiconductor device has.

14. The computer system, the data processor or the data processing method of claim 1, 2, 3, 4, 5, 10, 12 or 13,
wherein said memory network has a bus network structure.

15. The computer system, the data processor or the data processing method of claim 1, 2, 3, 4, 5, 10, 12 or 13,
wherein said memory network has a ring network structure.

16. A semiconductor integrated circuit comprising:
a semiconductor device serving as a memory and having a data processing function; and
changing means for dynamically changing a relationship between a logical address within a memory address space allocated to said semiconductor device and an actual physical address.

17. A computer system comprising:
plural memory networks; and
a semiconductor device having a data processing function,
wherein said semiconductor device is connected with said plural memory networks and has a data exchange function to transfer data between said plural memory networks.

18. A computer system comprising:
a semiconductor device connected with a memory network and having a data processing function and an image displaying function.
